(19) United States
(12) Patent Application Publication
(10) Pub. No.: US 2020/0269945 A1
(43) Pub. Date: Aug. 27, 2020

(54) MOTORCYCLE COVER

(71) Applicants: Scott E. Johnson, Boulder City, NV (US); John A. Romeo, Las Vegas, NV (US); Robert Edgar, Henderson, NV (US)

(72) Inventors: Scott E. Johnson, Boulder City, NV (US); John A. Romeo, Las Vegas, NV (US); Robert Edgar, Henderson, NV (US)

(21) Appl. No.: 16/542,063

(22) Filed: Aug. 15, 2019

Related U.S. Application Data
(60) Provisional application No. 62/810,063, filed on Feb. 25, 2019.

(51) Int. Cl. B62J 19/00

(52) U.S. Cl. CPC B62J 19/00

(57) ABSTRACT

Various examples of a motorcycle cover are provided. The cover can include a main body comprising a one or more layered material. The one or more layered material can include a flame resistant material, a heat reflective material, and a heat resistant material. The cover can also include one or more regions connected to and/or within the main body. The one or more regions can be configured to hold a stabilizing material to increase stability of the cover. The cover can be configured to protect the motorcycle within an inner side of the cover from a fire exterior to an outer side of the cover.

### CROSS-REFERENCE TO RELATED APPLICATIONS

This application claims the benefit of U.S. Provisional Patent Application No. 62/810,063, filed Feb. 25, 2019, which is incorporated in its entirety by reference herein.

### BACKGROUND

### Field

The present application relates generally to covers for motorcycles.

### Description of the Related Art

Motorcycle covers are known in the art, but such covers could be improved.

### SUMMARY

In various implementations, a motorcycle cover is provided. The cover can include a main body comprising a one or more layered material. The one or more layered material can comprise a flame resistant material, a heat reflective material, and a heat resistant material. The cover can also include one or more regions connected to and/or within the main body. The one or more regions can be configured to hold a stabilizing material to increase stability of the cover. The cover can be configured to protect a motorcycle within an inner side of the cover from a fire exterior to an outer side of the cover.

In some covers, the one or more layered material can comprise a first layer comprising the flame resistant material, a second layer comprising the heat reflective material, and a third layer comprising the heat resistant material. In some instances, the first layer can be adjacent the outer side, the third layer can be adjacent the inner side, and the second layer can be between the first and third layers.

In some covers, the flame resistant material can comprise an aramid, a polybenzimidazole, fiberglass, a silicate material, or a combination thereof. As an example, the flame resistant material can comprise a meta-aramid. As another example, the flame resistant material can comprise a para-aramid. As another example, the flame resistant material can comprise vermiculite fiberglass fabric. In some covers, the heat reflective material can comprise a foil. For example, the heat reflective material can comprise an aluminum foil. In some covers, the heat resistant material can comprise an aramid, a polybenzimidazole, fiberglass, a silicate material, or a combination thereof. For example, the heat resistant material can comprise vermiculite fiberglass fabric. As another example, the heat resistant material can comprise a meta-aramid. As another example, the heat resistant material can comprise a para-aramid. In some instances, the one or more layered material can be sewn together with a fire resistive thread.

In some implementations, the stabilizing material can comprise a liquid. For example, the liquid can comprise water. The one or more regions can be disposed adjacent the heat resistant material.

In some implementations, the one or more regions can be disposed along an edge of the main body. In some instances, the one or more regions can be disposed within the main body. In some instances, the one or more regions can be disposed between the one or more layered material of the main body.

In some instances, the cover can include a draw string configured to tighten the cover. In some instances, the cover can include one or more grommets configured to attach the cover to another object or to the ground.

### BRIEF DESCRIPTION OF THE DRAWINGS

FIG. 1 schematically illustrates an example cover for a motorcycle. FIG. 1 is not drawn to scale.

FIGS. 2, 3, 4, 5, and 6 show different views of an example cover for a motorcycle. The example cover includes a region that can be filled to increase the stability of the cover.

FIG. 7 shows an example connector configured to couple to an external source that can be used to fill the region of the example cover to increase the stability of the cover.

FIG. 8 schematically illustrates an example cover for a motorcycle.

FIG. 9 schematically illustrates a top view of the example cover shown in FIG. 8.

FIG. 10 schematically illustrates a side view of the example cover shown in FIG. 8.

FIG. 10A schematically illustrates a section of the example cover shown in FIG. 10 along an edge.

FIG. 11 schematically illustrates a front view of the example cover shown in FIG. 8.

FIG. 12 schematically illustrates a rear view of the example cover shown in FIG. 8.

FIG. 13 schematically illustrates a portion of the example cover shown in FIG. 8.

### DETAILED DESCRIPTION

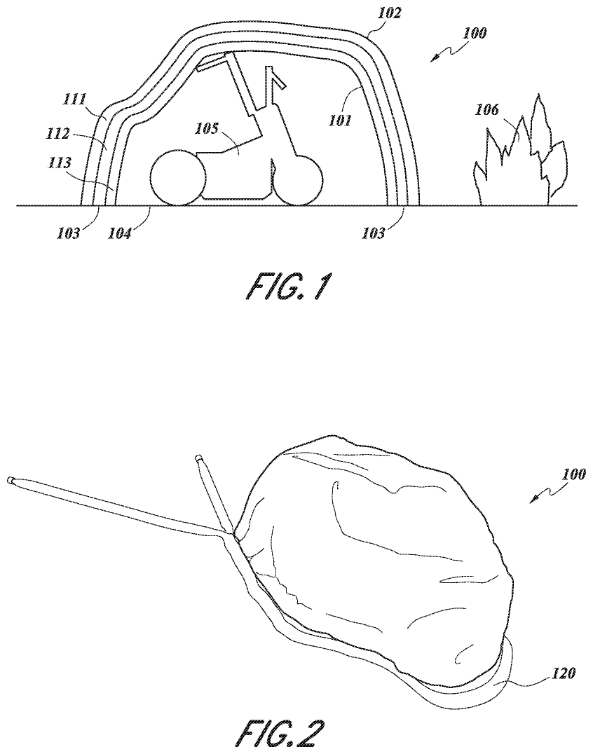

Fire can cause great damage to one's property such as to one's motorcycle. It is desirable to have a cover having a structure which facilitates protecting a motorcycle from fire. Such covers for motorcycles are described herein. FIG. 1 schematically illustrates an example cover for a motorcycle in accordance with certain implementations described herein. The example cover 100 can be sized (e.g., in length, width, height, etc.) to extend over a motorcycle 105. For example, the length can be in the range of 4 feet to 10 feet; the width can be in the range of 2 feet to 5 feet; and the height can be in the range of 3 feet to 5 feet. As shown in FIG. 1, the cover 100 has a first side, such as an inner side 101, and a second side such as an outer side 102. The cover 100 can be configured to protect the motorcycle 105 within the inner side 101 from a fire 106 exterior to the outer side 102. For example, the inner side 101 can include an inner surface of the cover 100, and the outer side 102 can include an outer surface of the cover. The cover 100 can also have an edge 103 configured to contact the ground 104 such that the motorcycle 105 can fit within an area formed by the inner side 101 and the ground 104.

In various implementations, the cover 100 can include a one or more layered material (e.g., one or more layers of fabric, textiles, cloths, woven fibers, etc.). As shown in FIG. 1, the one or more layered material can have a first layer 111, a second layer 112, and a third layer 113. The first layer 111 can include a fire or flame resistant material, the second layer 112 can include a heat reflective material, and the third layer 113 can include an insulating and/or heat resistant material. In some examples, the second layer 112 and/or the third layer 113 can also include a fire or flame resistant material. The first layer 111 can be adjacent the outer side 102 (e.g., the side that may contact the fire 106), and the third layer 113 can be adjacent the inner side 101 (e.g., the side that may contact the motorcycle 105). The second layer 112 can be disposed between the first layer 111 and the third layer 113.

The first layer 111 can include 30% to 100% of a flame resistant material. The first layer 111 can include at least 30%, at least 40%, at least 50%, at least 60%, at least 70%, at least 80%, at least 90%, or 100% of a flame resistant material or any range formed by any of the foregoing values. The flame resistant material can be configured to withstand high temperatures and resist flames and/or burning due to the fire 106. For example, the flame resistant material may be configured to withstand flames at temperatures of at least 100° C., at least 150° C., at least 200° C., or at least 260° C. The flame resistant material may be configured to withstand heat at temperatures of at least 500° C., at least 600° C., at least 700° C., or at least 800° C. In various implementations, the time the flame resistant material may be configured to withstand flames and/or heat may be related to the temperature, e.g., the lower the temperature, the longer the time. The flame resistant material can comprise an aramid, a polybenzimidazole, or a combination thereof. The aramid can include a meta-aramid (e.g., Nomex® by DuPont USA), a para-aramid (e.g., Kevlar® by DuPont USA), or a combination thereof. In some instances, the flame resistant material can comprise fiberglass, silicate material (e.g., phyllosilicate material), or a combination thereof (e.g., a vermiculite fiberglass fabric).

The second layer 112 can include 30% to 100% of a heat reflective material. The second layer 112 can include at least 30%, at least 40%, at least 50%, at least 60%, at least 70%, at least 80%, at least 90%, or 100% of a heat reflective material or any range formed by any of the foregoing values. The heat reflective material can be configured to reflect heat from the fire 106 penetrating the first layer 111 away from the third layer 113 and away from the motorcycle 105. The heat reflective material can be configured to reflect 50% to 100% heat. For example, the heat reflective material can be configured to reflect at least 50%, at least 60%, at least 70%, at least 80%, at least 85%, at least 90%, at least 95%, or 100% heat or any range formed by any of the foregoing values. In some instances, the heat reflective material may be configured to withstand heat at temperatures of at least 500° C., at least 600° C., at least 660° C., at least 700° C., or at least 800° C. In various implementations, the time the heat reflective material may be configured to withstand heat may be related to the temperature, e.g., the lower the temperature, the longer the time. The heat reflective material can comprise a foil, such as an aluminum foil.

The third layer 113 can include about 30% to about 100% of a heat resistant material. The third layer 113 can include at least 30%, at least 40%, at least 50%, at least 60%, at least 70%, at least 80%, at least 90%, or 100% of a heat resistant material or any range formed by any of the foregoing values. The heat resistant material can be configured to withstand high temperatures and/or resist flames and/or burning due to the fire 106. For example, the heat resistant material may be configured to withstand flames at temperatures of at least 100° C., at least 150° C., at least 200° C., or at least 260° C. The heat resistant material may be configured to withstand heat at temperatures of at least 500° C., at least 600° C., at least 700° C., or at least 800° C. In various implementations, the time the heat resistant material may be configured to withstand flames and/or heat may be related to the temperature, e.g., the lower the temperature, the longer the time. In some instances, the heat resistant material can have insulation properties and/or be configured to insulate the motorcycle 105 from conductive heat. The heat resistant material can be configured to conduct 0% to 20% heat. For example, the heat resistant material can be configured to conduct less than 20%, less than 15%, less than 10%, less than 5%, or 0% heat or any range formed by any of the foregoing values. The heat resistant material can comprise fiberglass, silicate material (e.g., phyllosilicate material), or a combination thereof (e.g., a vermiculite fiberglass fabric). In some instances, the heat resistant material can comprise an aramid, a polybenzimidazole, or a combination thereof. The aramid can include a meta-aramid (e.g., Nomex® by DuPont USA), a para-aramid (e.g., Kevlar® by DuPont USA), or a combination thereof.

FIG. 1 illustrates an example cover 100 having three layers with the first layer 111 comprising the flame resistant material, the second layer 112 comprising the heat reflective material, and the third layer 113 comprising the heat resistant material. In various implementations, the layering of materials can form a fire resistant cover. In some implementations, the layers 111, 112, 113 may be held together with a fire resistive material, e.g., sewn with a fire resistive thread or bonded with a high temperature fire resistive adhesive.

In some implementations, the cover 100 can have less than three layers with one or more layers comprising a combination of the flame resistant material, the heat reflective material, and/or the heat resistant material. In some embodiments, one layer may comprise two of the three materials. In some instances, one layer may comprise a flame resistant material and a heat reflective material, and another layer may comprise the heat resistant material. For example, one layer may comprise a composite material comprising flame resistant and heat reflective materials. As another example, one layer may comprise flame resistant and heat reflective materials woven together. As another example, one layer may comprise a single material having both flame resistant and heat reflective properties.

In some instances, a layer may comprise a flame resistant material, and another layer may comprise a heat reflective material and a heat resistant material. For example, one layer may comprise a composite material comprising heat reflective and heat resistant materials. As another example, one layer may comprise heat reflective and heat resistant materials woven together. As another example, one layer may comprise a single material having heat reflective and heat resistant properties.

In some embodiments, the cover 100 can comprise a single layer. For example, the single layer may comprise a composite material comprising flame resistant, heat reflective, and heat resistant materials. As another example, the single layer may comprise flame resistant, heat reflective, and heat resistant materials woven together. As another example, the single layer may comprise a single material having flame resistant, heat reflective, and heat resistant properties.

In some implementations, the three materials may form more than three layers. As an example, the cover 100 may contain additional layers of the flame resistant material, heat reflective material, heat resistant material, and/or combination thereof. In some instances, the cover 100 may contain additional layers of other materials. In various implementations, the one or more layered material can be flexible in order to cover a variety of motorcycle shapes and sizes. In some instances, the thickness of each layer can be in the range of 0.010 mil to 8.0 mils, although the thicknesses are not particularly limited. For example, the first layer 111, the second layer 112, and/or the third layer 113 can have thickness of 0.010 mil, 0.020 mil, 0.030 mil, 0.040 mil, 0.050 mil, 0.060 mil, 0.070 mil, 0.080 mil, 0.090 mil, 0.10 mil, 0.15 mil, 0.20 mil, 0.24 mil, 0.25 mil, 0.30 mil, 0.40 mil, 0.50 mil, 0.60 mil, 0.70 mil. 0.80 mil, 0.90 mil, 1.0 mil, 2.0 mils, 3.0 mils, 4.0 mils, 5.0 mils, 6.0 mils, 7.0 mils, 7.9 mils, 8.0 mils, or any range formed by any of the foregoing values. In some instances, the thickness of each layer can be between 1 mil and 150 mils, between 1 mil and 100 mils, between 1 mil and 75 mils, between 1 mil and 50 mils, between 1 mil and 25 mils, between 1 mil and 15 mils, or between 1 mil and 10 mils.

In some implementations, the cover 100 may include one or more regions (not shown in FIG. 1) configured to hold one or more stabilizing materials having a weight to increase stability of the cover 100 (e.g., to keep the cover 100 from blowing away in atmospheric conditions). For example, one or more regions configured to hold one or more stabilizing materials may be disposed within any of the layers shown in FIG. 1, e.g., within the first layer 111, the second layer 112, and/or the third layer 113 layer. As another example, one or more regions configured to hold one or more stabilizing materials may be disposed within a layer separate from the first layer 111, the second layer 112, and the third layer 113. For instance, one or more regions configured to hold one or more stabilizing materials may be disposed between any of the layers (e.g., between the first and second layers 111, 112, and/or between the second and third layers 112, 113), adjacent the third layer 113 on the inner side 101, and/or adjacent the first layer 111 on the outer side 102.

In some implementations, the stabilizing material may include a liquid, e.g., water. The stabilizing material may also be used as a safety measure. For example, if for some reason, the cover 100 burns or overheats, the one or more regions may break allowing the stabilizing material to be exposed to cool the cover 100 (and/or the motorcycle 105). In some instances, the one or more regions may break based on the heat and/or flame resistant rating. In some instances, the stabilizing material may soak any one or more of the flame resistant, heat reflective, and/or heat resistant materials. In one example, the stabilizing material may soak at least the material closest to the motorcycle 105, e.g., soak the heat resistant material. In some such examples, the stabilizing material may increase protection to a temperature of at least 800° C., at least 900° C., at least 1000° C., at least 1100° C., at least 1200° C., at least 1300° C., or at least 1400° C.

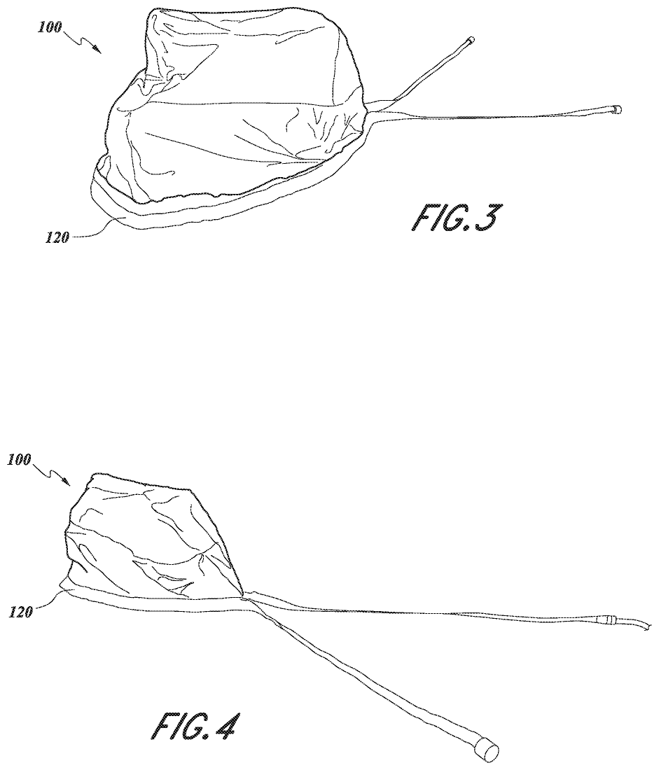

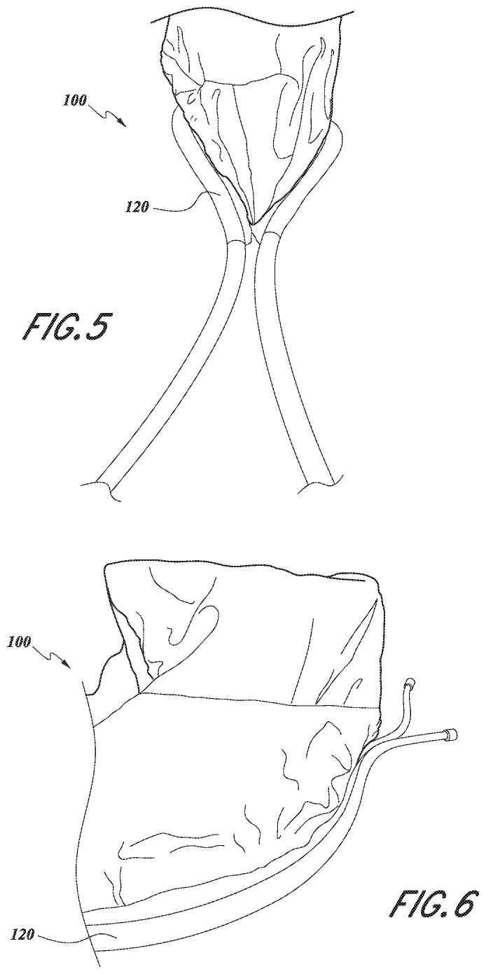

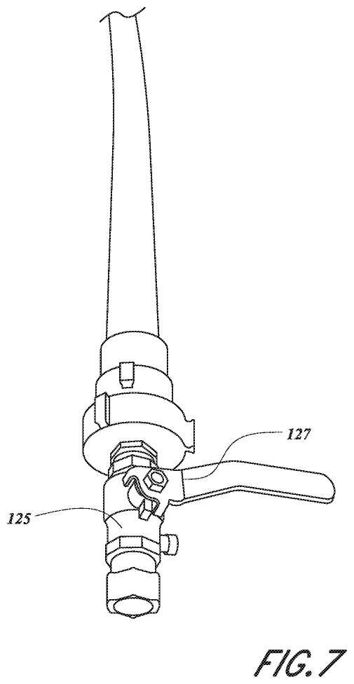

In some instances, the one or more regions configured to hold one or more stabilizing materials may be disposed adjacent at least a part of the edge 103 of the cover 100. FIGS. 2-6 show an example of the cover 100 with the region 120 configured to hold the stabilizing material adjacent the edge. When filled, the region 120 can form a weighted base. FIG. 7 shows an example connector 125 configured to couple to an external source that can be used to fill the region 120 with the stabilizing material. For example, the connector 125 can be configured to couple to an external hose to fill the region 120 with water from a water source (e.g., from a building's water line or a fire hydrant). When the region 120 is filled with the desired amount of water, the supply of water can be shut-off at the source. The connector 125 may also have a closure valve 127 such that the external hose can be decoupled from the cover 100.

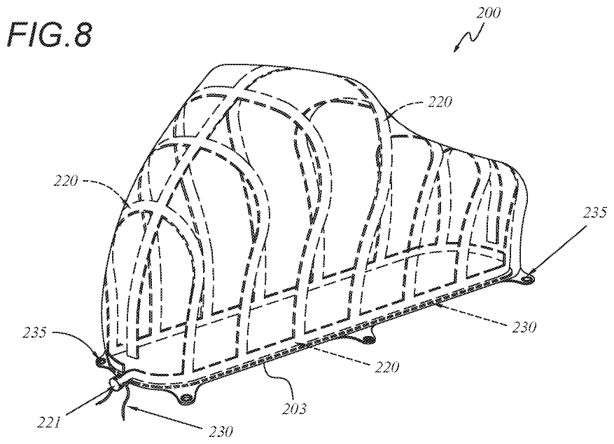

FIG. 8 schematically illustrates an example cover 200 for a motorcycle with regions 220 configured to hold one or more stabilizing materials. As shown in FIG. 8, the regions 220 can be disposed adjacent the edge 203 of the cover 200 and within and/or between the layers of the cover 200. In this example, the regions 220 are in the form of fluid channels. As described herein, the regions 220 can be filled from an external source. In this example, the regions 220 can be filled from an external source at input 221. Additionally or alternatively, the regions 220 can be filled at other locations. In some instances, the cover 200 may include a draw string 230. As shown in FIG. 8, the draw string 230 can be disposed along the edge 203 to tighten the cover 200. The cover 200 can be tightened prior to filling the regions 220. Additionally or alternatively, the cover 200 can be tightened during and/or after filling the regions 220. The draw string 230 can be any appropriate length and can be made of any appropriate material or combination of materials, including but not limited to, cotton, polyester, nylon, and/or linen. The cover 200 may also include one or more grommets 235. The grommets 235 can be any appropriate shape and size. In some instances, the grommets 235 can include a ring through which to connect to a string, rope, twine, cord, yarn, cable, hook, chain, etc. to attach to another object and/or to the ground. For example, the grommets 235 can be attached to another object fixed with respect to the ground.

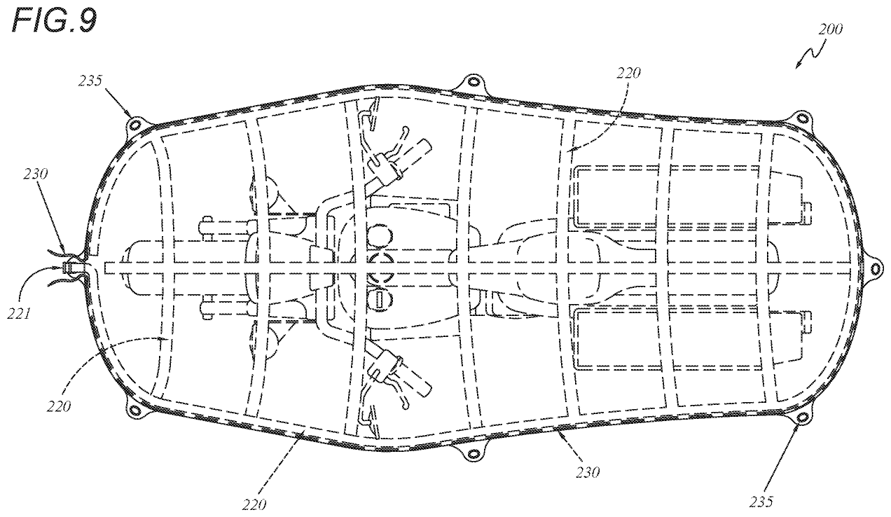

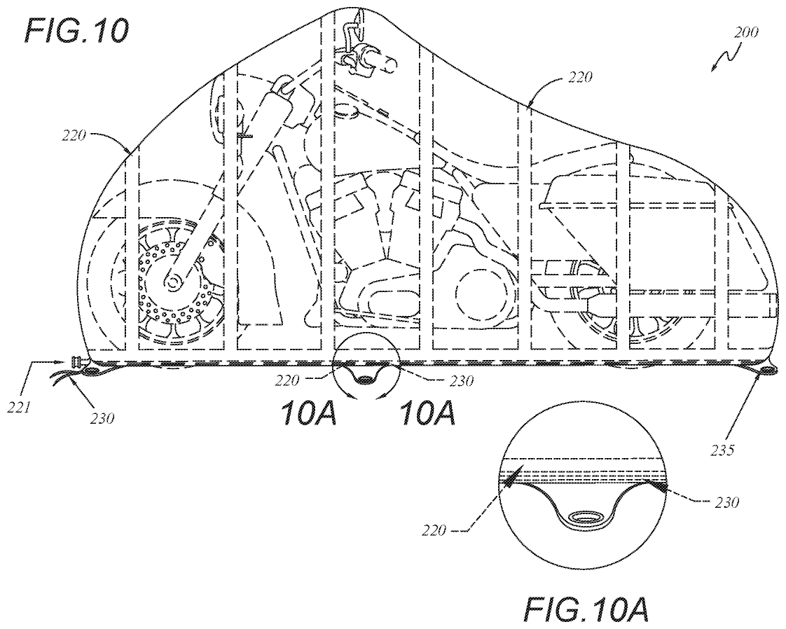

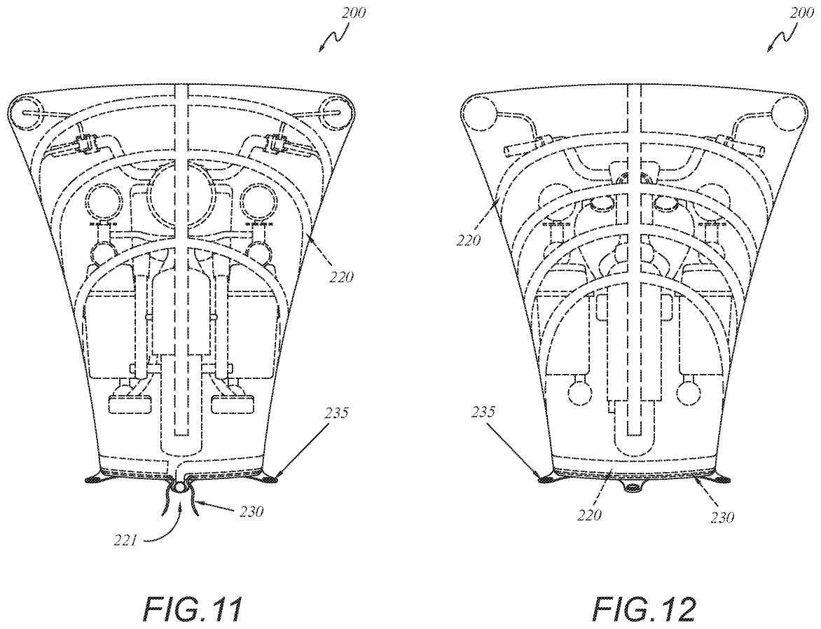

FIG. 9 schematically illustrates a top view of the example cover 200 shown in FIG. 8 with regions 220, draw string 230, and grommets 235. FIG. 10 schematically illustrates a side view of the example cover 200 shown in FIG. 8. As shown in FIGS. 10 and 10A, the regions 220, draw string 230, and grommets 235 can be disposed along the edge of the cover 200. FIGS. 11 and 12 schematically illustrate a front view and a rear view of the example cover 200 respectively.

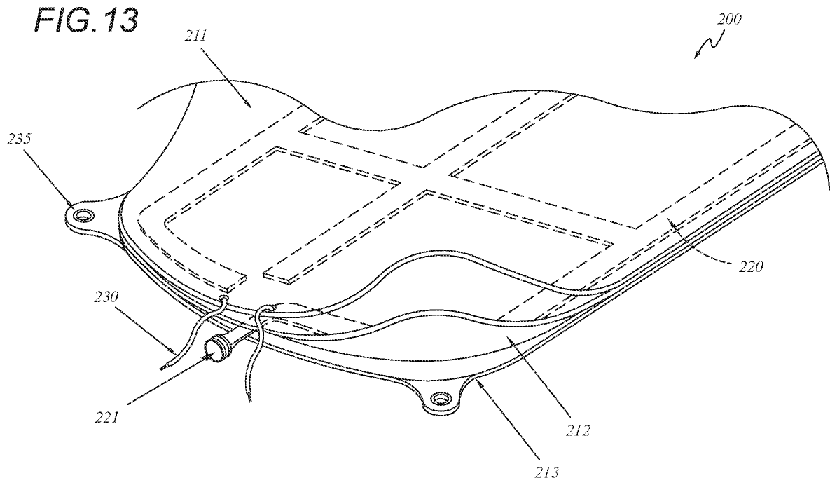

FIG. 13 schematically illustrates a portion of the example cover 200. As shown in FIG. 13, the cover 200 can include a first layer 211, a second layer 212, and a third layer 213. The first, second, and third layers 211, 212, 213 can be identical or similar in materials and/or properties as the first, second, and third layers 111, 112, 113 as described with respect to FIG. 1. In FIG. 13, the regions 220 are disposed between the second and third layers 212, 213. In other implementations, the regions 220 can be disposed within any one or more layers 211, 212, 213 and/or between any two layers 211, 212, 213. In FIG. 13, the draw string 230 is disposed within the first layer 211. However, in other instances, the draw string 230 can be disposed within any one or more layers 211, 212, 213 and/or between any two layers 211, 212, 213. In FIG. 13, the grommets 235 are disposed adjacent the third layer 213. In other implementations, the grommets 230 can be disposed along any one or more layers 211, 212, 213 and/or between any two layers 211, 212, 213. The locations of the regions 220, input 221 to the regions 220, draw string 230, and/or grommets 235 are not particularly limited.

As described herein, with reference back to FIG. 1, the cover 100 (or cover 200 in FIGS. 8-13) can be configured to protect a motorcycle 105 within an inner side 101 from a fire 106 exterior to an outer side 102. In some implementations, the cover 100 (or cover 200) can be used to cover other things.

Various embodiments have been described above. Although the invention has been described with reference to these specific embodiments, the descriptions are intended to be illustrative and are not intended to be limiting. Various modifications and applications may occur to those skilled in the art without departing from the true spirit and scope of the invention as defined in the appended claims.

What is claimed is:

1. A motorcycle cover comprising:
a main body comprising a one or more layered material, the one or more layered material comprising:
a flame resistant material;
a heat reflective material; and
a heat resistant material; and
one or more regions connected to and/or within the main body, the one or more regions configured to hold a stabilizing material to increase stability of the cover, wherein the cover is configured to protect a motorcycle within an inner side of the cover from a fire exterior to an outer side of the cover.

2. The motorcycle cover of claim 1, wherein the one or more layered material comprises:
a first layer comprising the flame resistant material;
a second layer comprising the heat reflective material; and
a third layer comprising the heat resistant material.

3. The motorcycle cover of claim 2, wherein the first layer is adjacent the outer side, the third layer is adjacent the inner side, and the second layer is between the first and third layers.

4. The motorcycle cover of claim 1, wherein the flame resistant material comprises an aramid, a polybenzimidazole, fiberglass, a silicate material, or a combination thereof.

5. The motorcycle cover of claim 4, wherein the flame resistant material comprises a meta-aramid.

6. The motorcycle cover of claim 4, wherein the flame resistant material comprises a para-aramid.

7. The motorcycle cover of claim 4, wherein the flame resistant material comprises vermiculite fiberglass fabric.

8. The motorcycle cover of claim 1, wherein the heat reflective material comprises a foil.

9. The motorcycle cover of claim 8, wherein the heat reflective material comprises an aluminum foil.

10. The motorcycle cover of claim 1, wherein the heat resistant material comprises an aramid, a polybenzimidazole, fiberglass, a silicate material, or a combination thereof.

11. The motorcycle cover of claim 10, wherein the heat resistant material comprises vermiculite fiberglass fabric.

12. The motorcycle cover of claim 10, wherein the heat resistant material comprises a meta-aramid.

13. The motorcycle cover of claim 10, wherein the heat resistant material comprises a para-aramid.

14. The motorcycle cover of claim 1, wherein the one or more layered material is sewn together with a fire resistive thread.

15. The motorcycle cover of claim 1, wherein the stabilizing material comprises a liquid.

16. The motorcycle cover of claim 15, wherein the liquid comprises water.

17. The motorcycle cover of claim 15, wherein the one or more regions are disposed adjacent the heat resistant material.

18. The motorcycle cover of claim 1, wherein the one or more regions are disposed along an edge of the main body.

19. The motorcycle cover of claim 1, wherein the one or more regions are disposed within the main body.

20. The motorcycle cover of claim 1, wherein the one or more regions are disposed between the one or more layered material of the main body.

21. The motorcycle cover of claim 1, further comprising a draw string configured to tighten the cover.

22. The motorcycle cover of claim 1, further comprising one or more grommets configured to attach the cover to another object or to the ground.
